(19) United States
(12) Patent Application Publication
(10) Pub. No.: US 2025/0391052 A1
(43) Pub. Date: Dec. 25, 2025

(54) VEHICLE CAMERA SYSTEM WITH MULTIPLE-CAMERA ALIGNMENT

(71) Applicant: VOLVO TRUCK CORPORATION, Göteborg (SE)

(72) Inventor: Nicolas BERNE, HEYRIEUX (FR)

(73) Assignee: VOLVO TRUCK CORPORATION, Göteborg (SE)

(21) Appl. No.: 19/239,337

(22) Filed: Jun. 16, 2025

(30) Foreign Application Priority Data
Jun. 17, 2024 (EP) 24182654.4

(51) Int. Cl. G06T 7/80; G06T 7/521; G07C 5/08; H04N 17/00

(52) U.S. Cl. CPC G06T 7/80; G06T 7/521; G07C 5/0808; H04N 17/002; G06T 2207/30252

(57) ABSTRACT

A computer system including processing circuitry for aligning at least a first camera and a second camera of a vehicle, the computer system is provided. The system is configured to project, from at least one light projector of the vehicle, a light pattern onto a ground spanning field views of the first camera and the second camera, obtain first image data from the first camera and second image data from the second camera, align a first distance overlay line with a first portion of the emitted light pattern of the first image data, and align a second distance overlay line with a second portion of the emitted light pattern of the second image data wherein the alignment of the first and second distance overlay line aligns the first and second camera in a ground plane.

### CROSS REFERENCE TO RELATED APPLICATIONS

This application claims foreign priority to European Patent Application No. 24182654.4, filed on Jun. 17, 2024, the disclosure and content of which is incorporated by reference herein in its entirety.

### TECHNICAL FIELD

The disclosure relates generally to camera systems in vehicles. In particular aspects, the disclosure relates to vehicle camera system with multiple-camera alignment. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Many vehicles are equipped with several cameras in a vehicle camera system. The plurality of cameras may be used for different purposes, such as for example in advance driver assistance systems (ADAS) to enhance safety and improve the driving experience for both autonomous and non-autonomous vehicles. Use of multiple cameras requires calibration with one another (e.g., left rearfacing camera, right rearfacing camera, and center rearfacing camera) to gain accurate data. When the cameras are physically moved or adjusted, to align the three cameras together in digital space typically requires manual calibration by a user. This manual alignment process takes a lot of time and is prone to cause inaccurate image readings. There is thus a need for a system for automatically aligning a plurality of cameras.

### SUMMARY

According to a first aspect of the disclosure, a computer system for aligning at least a first camera and a second camera of a vehicle, the computer system comprising processing circuitry configured to project, from at least one light projector of the vehicle, a light pattern onto a ground spanning field views of the first camera and the second camera, obtain first image data from the first camera, wherein the first image data includes a first portion of the emitted light pattern from the at least one light projector; obtain second image data from the second camera, wherein the second image data includes a second portion of the emitted light pattern from the at least one light projector; align a first distance overlay line with the first portion of the emitted light pattern of the first image data by adjusting the first distance overlay line or adjusting the first portion of the emitted light pattern; align a second distance overlay line with the second portion of the emitted light pattern of the second image data by adjusting the second distance overlay line or adjusting the second portion of the emitted light pattern, wherein the alignment of the first and second distance overlay line aligns the first and second camera in a ground plane.

The first aspect of the disclosure may seek to migrate the problems relating to the need of manually adjustment of the cameras, such as the adjustment between the left line and the right line, every time one of the cameras are moved or otherwise adjusted. Moreover, the first aspect of the disclosure may seek to migrate the problems relating to manual alignment of overlay distance line in each camera view where the driver has to leave the vehicle in order to perform the alignment. A technical benefit may include to achieve a common reference point for the driver across multiple cameras. Yet further, a technical benefit may include that the overlay lines corresponds to a real reference point which gives the possibility to check the alignment on a regular basis. A further technical benefit may include an efficient and cost-effective way of align the cameras without the need of a complete calibration process.

In some embodiments, the alignment of at least one of the first distance overlay line and the second distance overlay line is performed by receiving a user input. A technical benefit may include that the driver feels secure that the alignment is done properly while at the same time being able to sit in the vehicle during the alignment process.

In some embodiments, the alignment of at least one of the first distance overlay line and the second distance overlay line is performed automatically by the processing circuitry. A technical benefit may include a stable and efficient alignment process, reducing driver workload and improving overall vehicle safety by ensuring accurate camera alignment without requiring any manual intervention.

In some embodiments, the processing circuitry is further configured to display the first portion of the emitted light pattern and the first distance overlay line on at least one display, and/or display the second portion of the emitted light pattern and the second distance overlay line on at least one display. A technical benefit may include an efficient and user-friendly alignment process.

In some embodiments, the processing circuitry is further configured to obtain a first distance overlay line, and obtain a second distance overlay line.

In some embodiments, the processing circuitry is further configured to process position data of the first portion of the emitted light pattern and position data of the second portion of the emitted light pattern, align the first distance overlay line with the first portion of the emitted light pattern based on the position data; and align the second distance overlay line with the second portion based on the position data.

In some embodiments, wherein the ground plane is defined as a plane extending in the x and y direction. A technical benefit may include an efficient and cost-effective way of align the cameras without the need of a complete calibration process.

In some embodiments, the processing circuitry is further configured to process position data of the first portion of the emitted light pattern and position data of the second portion of the emitted light pattern, and reposition the field of view for the first camera and the second camera based on the position data.

In some embodiments, the processing circuitry is further configured to obtain information pertaining to the surrounding conditions of the vehicle; and adapt the emitted light pattern based on said obtained information. A technical benefit may include a more secure alignment process as the alignment can be performed in different conditions while still achieving good results.

In some embodiments, the adaptation of the emitted light pattern comprises changing the wavelength of the emitted light, changing the intensity of the emitted light and/or changing the shape of the emitted light pattern. A technical benefit may include a more secure alignment process as the alignment can be performed in different conditions while still achieving good results.

In some embodiments, the information pertaining to the surrounding conditions of the vehicle comprises one or more of: temperature, humidity, weather, air pressure, wind speed, solar radiation, pollution levels, and road surface conditions. A technical benefit may include a more secure alignment process as the alignment can be performed in different conditions while still achieving good results.

In some embodiments, the processing circuitry is further configured to identify at least one of the shape of the light pattern, the first portion or the second portion, wherein the shape is associated with an identifier containing characteristics of the vehicle. A technical benefit may include a faster and more vehicle specified alignment process.

In some embodiments, the shape of the light pattern, the first portion and/or the second portion is a bar code or a logotype of the vehicle brand. A technical benefit may include a more user-friendly alignment process.

In some embodiments, the processing circuitry is further configured to obtain third image data from a third camera, the third image data including a third portion of the emitted light pattern from the at least one light projector; align a third distance overlay line with the third portion of the emitted light pattern of the first image data; process position data of the first portion of the emitted light pattern, position data of the second portion of the emitted light pattern and position data of the third portion of the emitted light pattern to align the first camera, the second camera and the third camera relative to each other. A technical benefit may include that it is possible to align several cameras in a time efficient manner.

According to a second aspect of the disclosure, a vehicle comprising at least one light projector, a camera system and the computer system. The second aspect of the disclosure may seek to eliminate the need for lengthy calibration processes of cameras.

In some embodiments, at least one light projector is arranged on a rear portion of the vehicle. A technical benefit may include that the light pattern is visible from cameras arranged on the right and left side of the vehicle, thus providing an effective alignment process.

In some embodiments, camera system comprises at least two cameras, being a left rear-facing camera, a right rear-facing camera or a center rear-facing camera. A technical benefit may include an effective alignment process.

According to a third aspect of the disclosure, a computer-implemented method comprising: projecting, from at least one light projector of a vehicle, a light pattern onto a ground spanning field views of a first camera and a second camera, obtaining, from a camera system, first image data from the first camera, and second image data from the second camera, wherein the first image data includes a first portion of the emitted light pattern from the at least one light projector; obtaining, from a camera system and wherein the second image data includes a second portion of the emitted light pattern from the at least one light projector; aligning a first distance overlay line with the first portion of the emitted light pattern of the first image data by adjusting the first distance overlay line or adjusting the first portion of the emitted light pattern; and aligning a second distance overlay line with the second portion of the emitted light pattern of the second image data by adjusting the second distance overlay line or adjusting the second portion of the emitted light pattern.

The disclosed aspects, examples, and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIGS. 1A-D are exemplary vehicles according to different examples.

FIG. 2 is an exemplary system diagram according to an example.

FIGS. 3A-E are exemplary vehicles according to different examples.

FIGS. 4A-I are exemplary light patterns according to different examples.

FIGS. 5A-B are exemplary displays according to different examples.

FIG. 6 is an exemplary system diagram according to an example.

FIG. 7 is a flow chart of an exemplary method according to an example.

FIG. 8 is another view of FIG. 6, according to an example.

FIG. 9 is a flow chart of an exemplary method according to an example.

FIG. 10 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

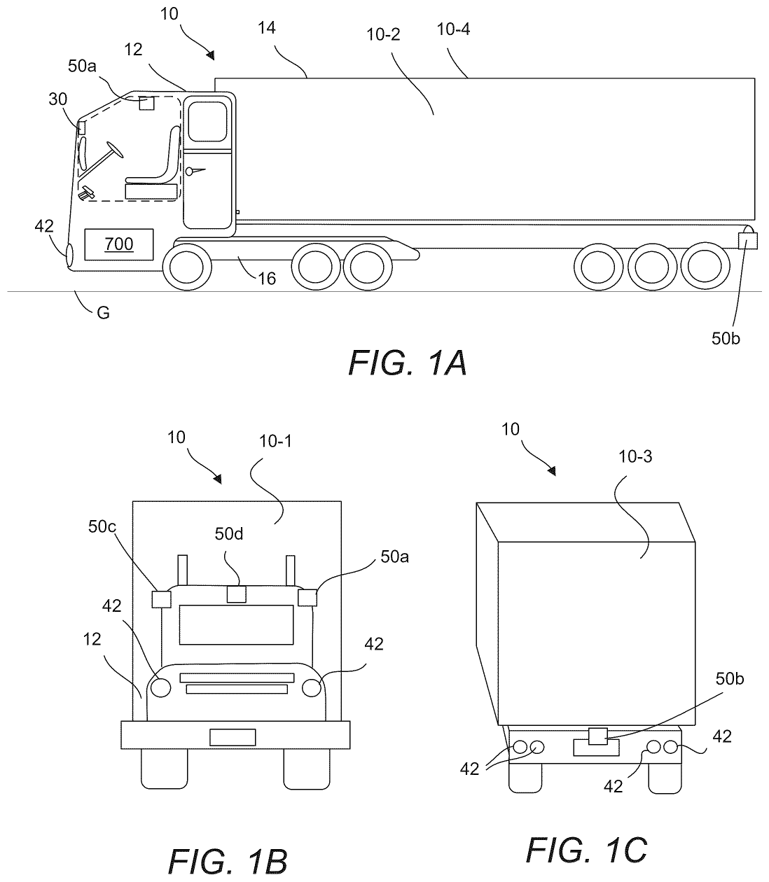

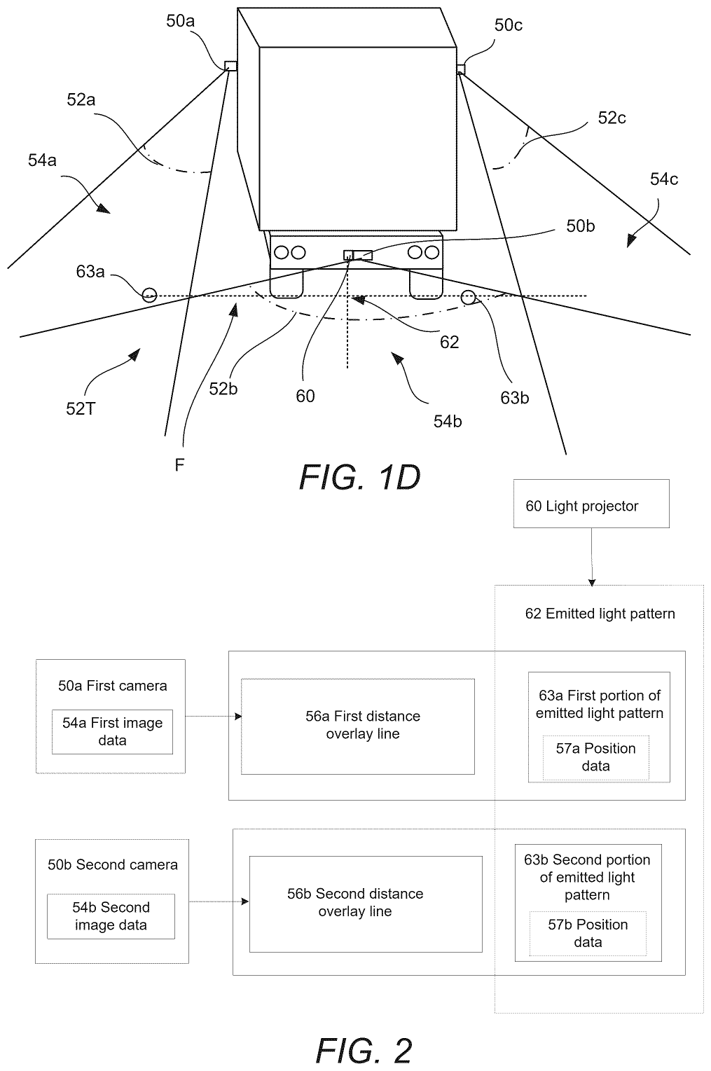

FIGS. 1A-1C are exemplary schematic illustrations of a vehicle 10. The vehicle 10 is illustrated as a heavy-duty vehicle, but other vehicle types may be used. The vehicle 10 in FIG. 1A is shown from a first side 10-2, and includes a corresponding second side 10-4 at an opposing side. FIG. 1C shows a vehicle 10 from its rear side 10-3. This vehicle 10 comprises a tractor unit 12 which is arranged to tow a trailer unit 14. In other examples, other heavy-duty vehicles may be employed, e.g., trucks, buses, and construction equipment. The vehicle 10 comprises vehicle units and associated functionality as would be understood and expected by a skilled person, such as a powertrain, chassis, and various control systems.

Heavy-duty vehicles present unique challenges for camera alignment due to their size, articulation, and load variations. The length of these vehicles can make it difficult to establish a stable reference point for alignment, and the articulation between the tractor and trailer can introduce additional degrees of freedom that must be accounted for. Furthermore, the load carried by the vehicle can significantly affect its ride height and orientation, requiring frequent camera realignment to maintain accurate sensor data. The camera alignment system described herein addresses these challenges by providing an automated, reliable, and adaptable solution that can compensate for these factors, ensuring accurate sensor data regardless of the vehicle's configuration or operating conditions.

The vehicle 10 is arranged on a surface G. The surface G may for example be ground surface such as concreate, asphalt, gravel, earthen, murrum, grass, or any suitable flooring materials used in machine halls or similar.

The vehicle 10 further comprises a plurality of exterior lights 42 (hereinafter referred to as lights 42 for reasons of brevity). The lights 42 are arranged exterior to the vehicle 10, such that they may be directly or indirectly (for instance through a reflection) visible to objects in the vicinity of the vehicle 10. The lights 42 may be any suitable device capable of emitting a light, such as OLEDS, QLEDs, Micro LEDs, RGB LEDs, projector lights. Exemplary lights 42 of the vehicle 10 may include braking lights, headlights, rear lights, emergency alert lights, construction zone warning lights, lane changing signals, hazard lights, deceleration indicators, road awareness lights, turn signal lights, fog lights, and/or any additional type of lights which may be utilized by various types of vehicles.

The vehicle 10 comprises a plurality of sensors 50a-50d (may be referred to collectively as sensors 50). The sensor 50 may be a camera, a lidar sensor, a radar sensor, an ultrasonic sensor or an infrared sensor. The sensors 50 are configured to sense the surroundings of the vehicle 10. The range and responsiveness of the sensors 50 may depend on sensor type, sensor location, lens type, image sensor resolution, lighting conditions, ambient conditions (e.g., weather, humidity, fogginess), conditions of electronic components, potential obstructions in the field of view, latencies in computer systems, etc.

In some examples, the sensor 50 is a smart sensor configured to process sensed information and make a detection decision related to a detection of an object. For instance, the smart sensor may be able to detect lane markings, other vehicles, pedestrians, traffic signals, or road signs. The smart sensor may comprise a microcontroller, processor (e.g., PLC, CPU, DSP), FPGA, ASIC or any other suitable digital and/or analog circuitry capable of processing sensing data. The smart sensor may further comprise a memory implemented in any known memory technology, including but not limited to E (E) PROM, S (D) RAM or flash memory. The memory may be integrated with or internal to the microcontroller/processor/circuitry. This processing capability allows the sensor to filter out noise, compensate for lighting variations, and prioritize relevant data, resulting in more accurate and reliable input for the camera alignment system.

In other examples, the sensor 50 is a sensor not capable of processing information itself. Unlike smart sensors, which have built-in processing capabilities to interpret and analyze data, “dumb” sensors or “passive” sensors are devices that detect and measure physical properties or phenomena without any processing or interpretation of the sensing data being collected. These sensors typically generate raw analog or digital signals that need to be processed by external systems or devices to derive meaningful information or insights.

The sensor 50 may be operatively connected (e.g., wired or wirelessly) to suitable devices, systems and features of the vehicle 10. The wireless interface and associated communication protocols may be based on any known communication technology known in the art, such as one or more of HTTP(S), TCP/IP, UDP, FTP, SMTP, DNS, DHCP, SSH, POP3, SCP, NFS, SFTP, ICMP, ARP, RTP, RTCP, IEEE 802.11, IEEE 802.15, ZigBee, WirelessHART, WiFi, Bluetooth®, BLE, RFID, WLAN, MQTT IoT, CoAP, DDS, NFC, AMQP, LoRaWAN, Z-Wave, Sigfox, Thread, EnOcean, mesh communication, any form of proximity-based device-to-device radio communication, LTE Direct, W-CDMA/HSPA, GSM, UTRAN, LTE, IPv4, IPV6, 6LoWPAN, IrDA, or 5G NR.

In the example of FIGS. 1A-C the sensors are cameras 50. In FIGS. 1A-C the vehicle is arranged with a left rear-facing camera 50a, a right rear-facing camera 50b and a center rear-facing camera 50c. In other examples, the vehicle 10 may comprise front view camera(s) and side view camera. In some examples, the vehicle 10 may include different sensor arrangements having one or more cameras 50 arranged at any suitable location with respect to the vehicle 10, such as at the tractor unit 12 or the trailer unit 14, a wheel portion 16, and the like.

The vehicle 10 further comprises a visual information module 30 configured to display visual information to the user. The visual information module 30 may comprise one or more display units. A display unit may for example be a liquid crystal display (LCD) or a cathode ray tube (CRT). In one example, the visual information module 30 may e.g., comprise a head-up display HUD or an augmented reality display configured to display visual information to the user. The visual information module 30 is configured to display the emitted light pattern, the distance overlay lines, and the alignment status to the user. This allows the driver to monitor the alignment process in real-time and verify the accuracy of the camera alignment, providing a clear and intuitive interface for the system. The display can be arranged in various configurations to optimize the user experience. For example, a single display unit can be split into multiple screens, each dedicated to displaying a different camera view or alignment parameter. Alternatively, the visual information module 30 may comprise multiple physical display units, each positioned to provide a convenient viewing angle for the driver. In some embodiments, the augmented reality display may overlay the alignment information directly onto the driver's view of the road, providing a seamless and intuitive integration of the system into the driving experience.

The vehicle 10 further comprises a computer system 700. The computer system 700 is advantageously operatively connected to all suitable devices, systems and features of the vehicle 10, such as the sensors 50. The computer system 700 is configured to obtain sensing data from the sensors 50 and will be discussed more in detail with reference to FIG. 2B.

In the example shown in FIG. 1D, the vehicle 10 comprises a camera system comprising at least a left rear-facing camera 50a, a right rear-facing camera 50c and a center rear-facing camera 50b. The left rear-facing camera 50a is configured to capture image data 54a of an area of the left-rear side of the vehicle 10, which is between the left side of the vehicle 10 and the rear side of the vehicle 10. The right rear-facing camera 50c is configured to capture image data 54c of an area of the right-rear side of the vehicle, which is between the right side of the vehicle 10 and the rear side of the vehicle 10. The center rear-facing camera 50b is configured to capture image data 54 of an area of the rear side of the vehicle.

The cameras 50a-c each have a respective field-of-view 52a-c. The left rear-facing camera 50a may capture an image 54 of the left rear field of view to acquire an image of the left rear field of view 52a. The right rear-facing camera 50c may capture an image 54 of the right rear field of view to acquire an image 54 of the right rear field of view 52c. The center rear-facing camera 50b may capture an image of the center field of view to acquire an image of the center rear field of view 52b.

The cameras 50 may generate an overlapping field of view 52T, which is an area where at least two field of view overlap. The overlap may for example be an overlap between the center rear field of view 52b and the left rear-facing camera 50a or an overlap between the center rear field of view 52b and right rear field of view 52c.

In one example, the cameras 50 are high-resolution cameras. The resolution may for example be ranging between 720p and 1080p. The cameras 50 may have wide-angle lenses that provide a wide field of view.

In one example, the plurality of cameras 50a-c are asymmetrically arranged. The plurality of cameras may be asymmetrically arranged in relation to each other and/or in relation to the vehicle.

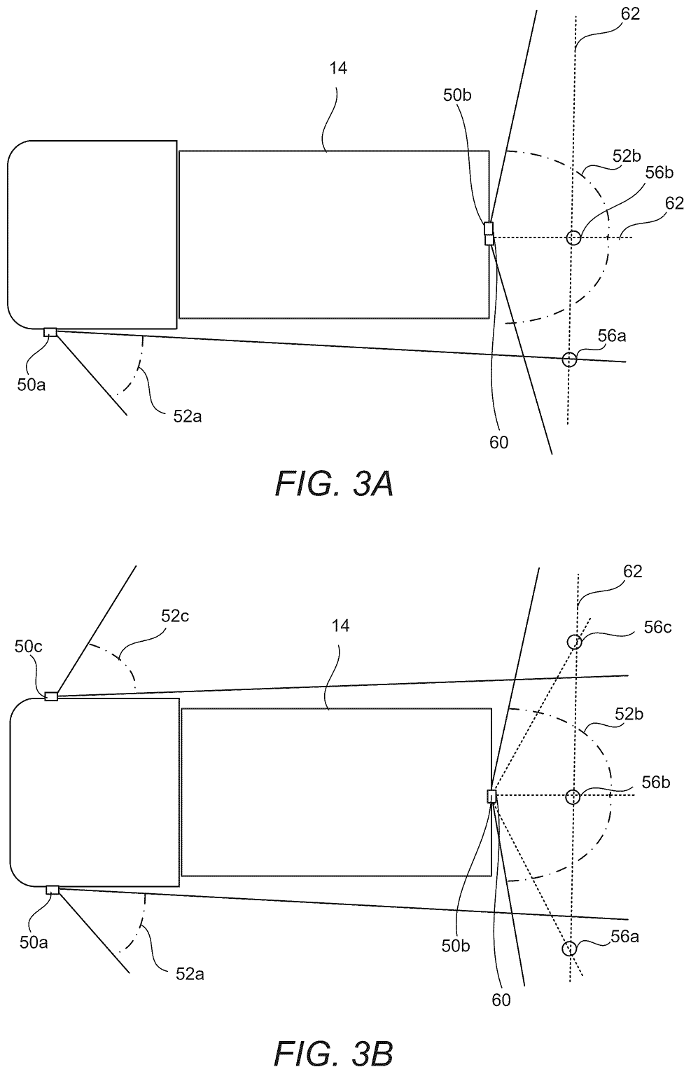

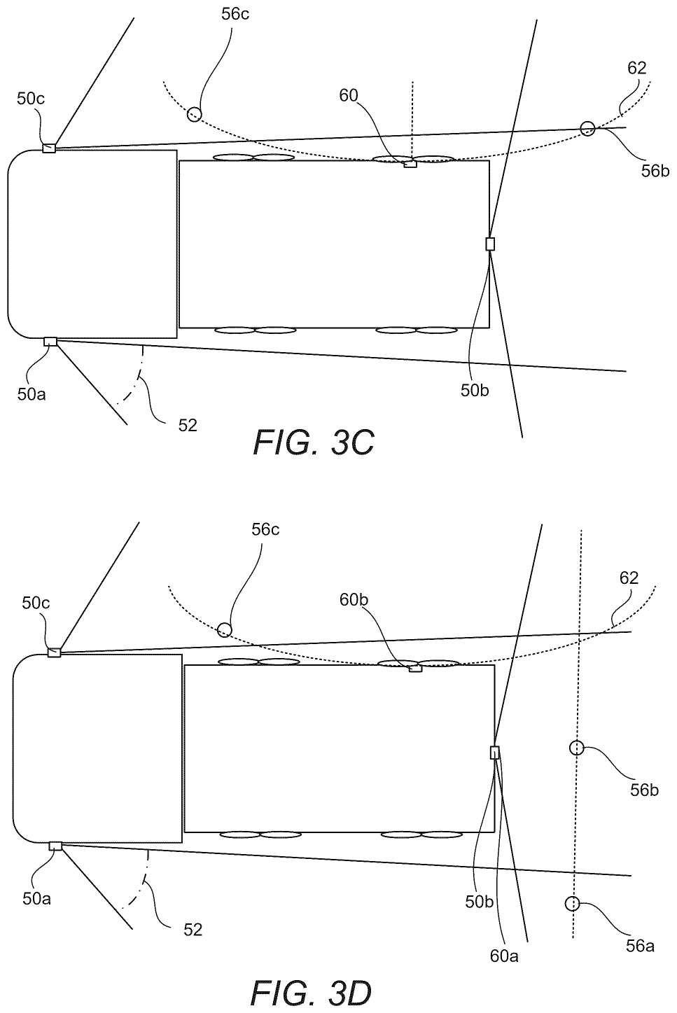

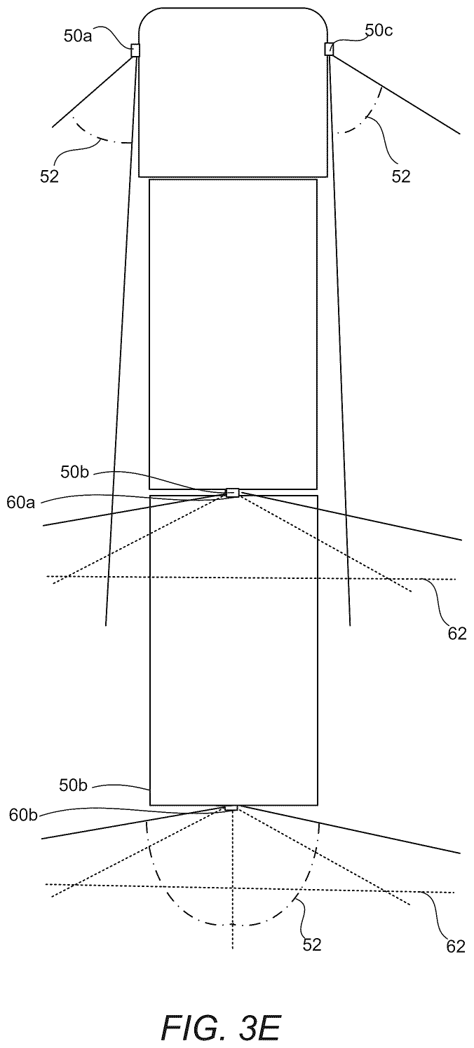

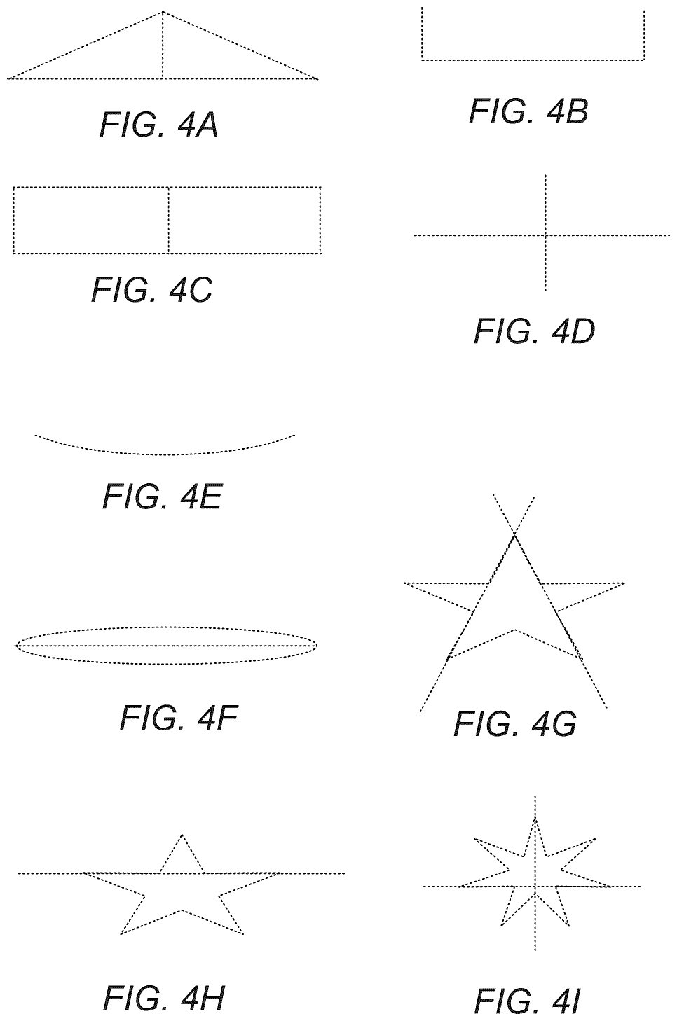

There is a need for a simplified calibration or alignment process so that the cameras can be aligned with one another. In order to achieve the alignment, the vehicle 10 is arranged with at least one light projector 60. The light projector 60 is configured to project a light pattern 62 (as illustrated in FIGS. 3-4) onto the ground G. The light projector 60 emits an emitted light pattern 62 comprising at least a first portion 63a and a second portion 63b. Existing camera calibration processes often require specialized equipment, manual adjustments, and significant time and expertise. In contrast, the present disclosure provides a simplified process that can be performed automatically or with minimal user input, reducing the time required for calibration and eliminating the need for specialized equipment or training.

FIG. 2 illustrates an example of such an improved alignment system. In this example the vehicle 10 comprises at least a first camera 50a and a second camera 50b. The first camera 50a generates a first image data 54a. The second camera 50b generates a second image data 54b. The light projector 60 projects an emitted light pattern 62 onto the ground. The light projector 60 may also be referred to as a level or an optical level. The light projector 60 may be an optical instrument configured to emit light to a surface. In one example the optical instrument is a lens. In one example the optical instrument is a reflector. In one example the light projector 60 comprises a laser.

The emitted light pattern 62 comprises at least a first portion 63a and a second portion 63b. The first portion 63a and a second portion 63 may be different from each other, or refer to the same portion of the pattern. The first image data 54a obtained from the first camera 50a includes a first portion 63a of the emitted light pattern 62. The second image data 54b obtained from the second camera 50b includes a second portion 63b of the emitted light pattern 62. The aim is to align the first camera 50a and the second camera 50b relative each other by aligning a first distance overlay line 56a with the first portion 63a of the emitted light pattern 62 of the first image data 54a, and aligning a second distance overlay line 56b with the second portion 63b of the emitted light pattern of the second image data 54b. This alignment may be achieved by precisely matching the position and orientation of the distance overlay lines 56a, 56b with the corresponding features in the emitted light pattern 62 as captured by the cameras 50a, 50b ensuring an accurate and reliable representation of the real-world environment. Compared to traditional methods that rely on fixed calibration targets or complex mathematical models, the use of an emitted light pattern provides a more robust and adaptable alignment solution. The emitted light pattern can be projected onto any surface, regardless of its texture or reflectivity, and its shape and intensity can be adjusted to compensate for varying lighting conditions. This allows the camera alignment system to operate effectively in a wider range of environments and scenarios than existing methods.

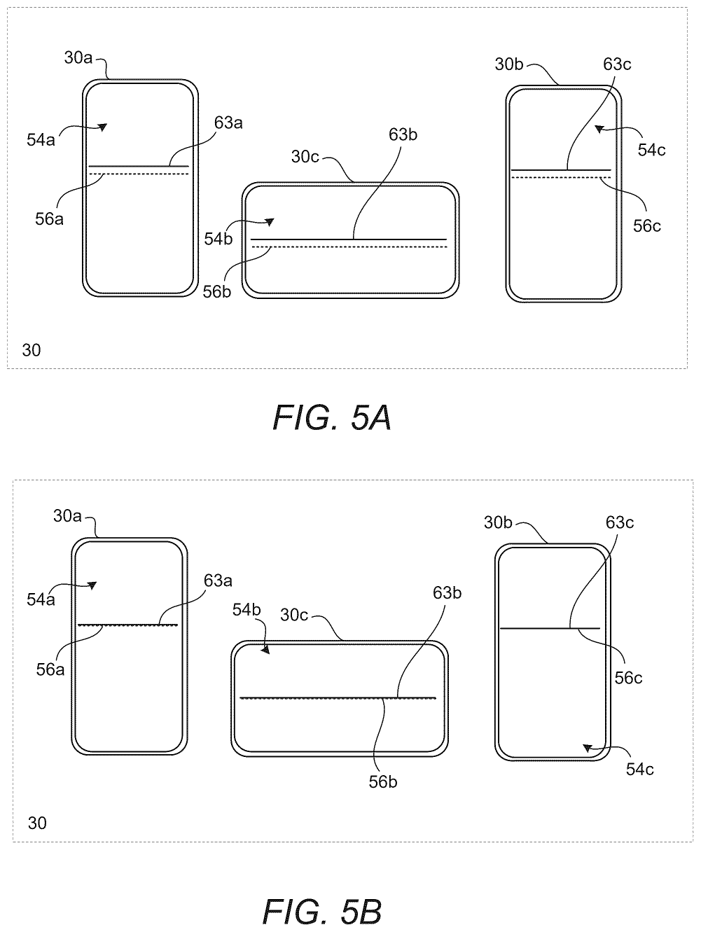

In one example, the distance overlay lines 56a, 56b are part of the image data 54a, 54b received from the cameras 50a, 50b. The distance overlay lines 56a, 56b may be a mask or layer that is put on top of the image received from the cameras 50a, 50b, as illustrated in FIGS. 5A-B. In one example the distance overlay lines 56a, 56b are added to the image data 54a, 54b by the computer system 700. The distance overlay lines 56a and 56b may be configured in various ways to enhance their visibility and functionality. For example, the overlay lines may be color-coded to distinguish them from the emitted light pattern or other elements in the image. The thickness of the lines may be adjusted to provide a clear visual indication without obscuring the underlying image data. The lines may also be animated or include dynamic elements that change based on the alignment parameters, providing a more interactive and informative display. In some embodiments, the overlay lines may be replaced with more complex graphical indicators, such as arrows, boxes, or other shapes, to provide a more intuitive representation of the alignment status. The overlay lines can also be dashed, dotted, or solid. Furthermore, the overlay lines may be configured to change color or blink when the alignment is out of tolerance, providing a clear warning to the driver.

In one example, adjusting the camera settings (such as for example zooming), the overlay lines will automatically adjust based on the adjustments made. In one example, the overlay lines will follow the zoom ratio. FIGS. 3A-E shows different examples of a vehicle 10 with at least one light projector 60. The light projector 60 emits a light pattern 62 onto the ground surface G. The ground surface G is preferably the ground onto which the vehicle 10 is arranged. The emitted light pattern 62 is projected onto the ground surface G. In some embodiments, the camera alignment process is performed when the vehicle 10 is stationary to ensure accurate and stable measurements.

The at least one light projector 60 may be arranged at various positions at the vehicle, such as at the tractor unit 12, the trailer unit 14, near a wheel portion 16, and the like. In one example, the light projector 60 is arranged on a rear portion of the vehicle 10. The light projector 60 may be arranged on the rigid body or on a trailer. In one example the light projector 60 is arranged at or proximate one or more lights 42, for example at or proximate to the brake and/or turn lights 42.

In one example as illustrated in FIG. 3A, the vehicle 10 is arranged with one light projector 60 arranged at a lower rear portion of the vehicle 10. More specifically, the light projector 60 is arranged at a lower rear portion of the trailer 14.

In the example of FIG. 3A, the vehicle is arranged with at least two cameras 50a, 50b generating first image data 54a and second image data 54b, respectively. In this example, the light pattern 62 is a plurality of lines. In the example illustrated in FIG. 3A, the light pattern 62 comprises of a plurality of lines arranged in a specific pattern. The emitted light pattern 62 comprises at least a first portion 63a and a second portion 63b. The first and second portion 63a, 63b may be arranged on or inside the field-of-view 52a-b.

In the example of FIG. 3B, the vehicle is arranged with at least three cameras 50a, 50b, 50c generating first image data, second image data, third image data, respectively. In the example illustrated in FIG. 3B, the light pattern 62 comprises of a plurality of lines arranged in a specific pattern. The light pattern 62 comprises of a curved line, having a center line arranged in its center point. The emitted light pattern 62 comprises at least a first portion 63a, a portion 63b and a third portion 63c. The first, second or third portions 63a, 63b may be arranged on or inside the field-of-view 52a-c.

In one example as illustrated in FIG. 3C, the vehicle 10 is arranged with one light projector 60 arranged at the left side of the vehicle 10.

In one example as illustrated in FIG. 3D, the vehicle 10 is arranged with two light projectors 60. The first light projector 60a is arranged at the rear portion of the vehicle 10 and emits a light pattern 62 towards the rear area of the vehicle 10. The second light projector 60b is arranged at a side portion of the vehicle 10, and emits a light pattern 62 towards the side of the vehicle 10. In this example, the light pattern 62 emitted from the first light projector 60a and the second light projector 60b differ in from one another.

In one example as illustrated in FIG. 3E, the vehicle 10 is arranged with two light projectors 60, each arranged at a lower rear portion of the vehicle 10. More specifically, the first light projector 60a is arranged at a lower rear portion of the first trailer 14a and the second light projector 60b is arranged at a lower rear portion of the second trailer 14b.

The light pattern 62 may be of different shapes and sizes. In addition to the examples described with reference to FIGS. 3A-E, further examples are illustrated in FIGS. 4A-I. The light pattern 62 may be in the form of a triangle, a triangle having a center line (as shown in FIG. 4A), a horizontal line having vertical endings (FIG. 4B), a rectangular box, a rectangular box having a center line (FIG. 4C), a cross (FIG. 4D), a curved portion (FIG. 4E), an ellipse, an ellipse having a center line (FIG. 4F), a star, a star having two diagonal lines (FIG. 4G), a star having one horizontal line (FIG. 4H), or a star having a cross (FIG. 4I). The above examples are not limiting, and the light pattern 62 may take many other shapes and sizes. As an additional example, the light pattern 62 may take the form of a logotype of the particular vehicle brand. Yet further, the light pattern 62 may be in the form of a bar code, for example a QR-code, associated with an identifier which in turn may be associated with characteristics of the vehicle 10. In other words, the shape of the whole light pattern 62, the first portion 63a and/or the second portion 63b may be a bar code or a logotype of the vehicle brand. The emitted light pattern 62 may be a structured light pattern, comprising a specific arrangement of light points, lines, or shapes designed to encode information about the vehicle's surroundings. For example, the structured light pattern may include a grid of light points with varying spacing or intensity, or a series of coded stripes that can be decoded by the cameras 50 to determine the distance and orientation of objects in the scene. The structured light pattern may also include unique identifiers or markers that are specific to the vehicle model or configuration, allowing the alignment system to automatically adapt to different vehicle types. This coded information enhances the robustness and accuracy of the alignment process by providing a more detailed and informative representation of the projected pattern.

The emitted light may be of any suitable wavelength. In one example the emitted light is in the visible light spectrum. Hence, the emitted light is in the range between 380-750 nm. The color of the emitted light pattern 62 may vary. In one example, the emitted light is in the infrared (IR) spectrum. Hence, the emitted light is in the range between 700 nm-1 mm.

In one example, the light emitted from the light projector 60 is of a predetermined intensity or brightness. The intensity of the emitted light pattern 62 may vary. In one example the light pattern is a continuous line. In one example the light pattern comprises separated lines.

FIGS. 5A-B are exemplary views of a visual information module 30 configured to display visual information to the user. In this specific example the visual information module 30 comprises a first display 30a, a second display 30b and a third display 30c. Each display 30 is configured to display visual information relating to the cameras 50 of the vehicle. The first display 30a is configured to display information of the image captured by the left rear-facing camera 50a. The second display 30b is configured to display information of the image captured by the right rear-facing camera 50c. The third display 30c is configured to display information of the image captured by the center rear-facing camera 50b. As is readily understood by a person skilled in the art, all images of the plurality of cameras could be arranged in one single display 30 having different viewing points for the different images.

In the illustrative example shown in FIG. 5A, the displays 30a-c are showing image data 54a, 54b, 54c captured by the cameras 50a-c when the light leveling 60 is emitting a light pattern 62. The image data 54a, 54b, 54c each comprises a portion 63a, 63b, 63c of the emitted light pattern 60. The portions 63a, 63b, 63c of the emitted light pattern 60 are in this example exemplified as a straight line. The displays 30a-c are also configured to show a first, second and third distance overlay lines 56a, 56b, 56c. The first, second and third distance overlay lines 56a, 56b, 56c are in this example exemplified as a dotted straight line. In the illustrative example shown in FIG. 5A, the cameras are not yet aligned relative each other. The first, second and third distance overlay lines 56a, 56b, 56c are thus not aligned with the respective portions 63a, 63b, 63c of the emitted light pattern 60.

In the illustrative example shown in FIG. 5B, the cameras have been aligned relative each other. The first, second and third distance overlay lines 56a, 56b, 56c are aligned with the respective portions 63a, 63b, 63c of the emitted light pattern 60.

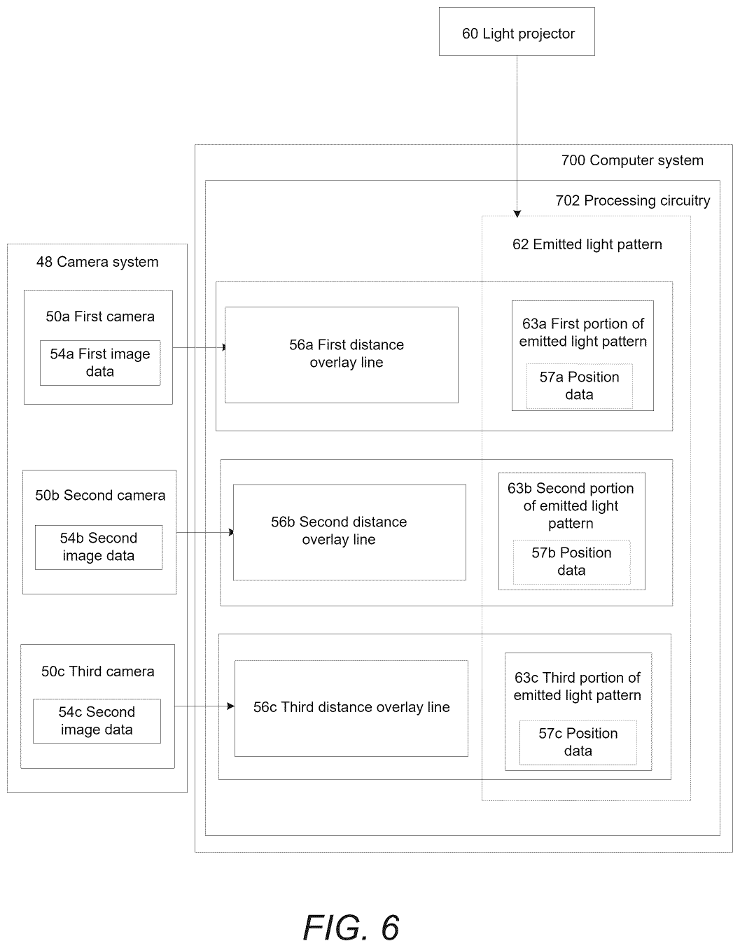

FIG. 6, depicts a computer system 700 according to an example. The computer system 700 comprises processing circuitry 702. The processing circuitry 702 is configured to obtain image data 54a, 54b, 54c from the first, second and third cameras 50a, 50b, 50c of the camera system 48 of the vehicle 10. The at least one light projector of a vehicle, projects a light pattern 62 onto a ground spanning field views F of the first camera 54a, the second camera 54b and the third camera 54c. In one example, the cameras are asymmetrically arranged. In one example, the alignment process is especially beneficial for asymmetric camera settings.

The first image data 54a includes a first portion 63a of the emitted light pattern from the at least one light projector. The second image data 54b includes a second portion 63b of the emitted light pattern 62 from the at least one light projector 60. The third image data 54c includes a third portion 63c of the emitted light pattern 62 from the at least one light projector 60.

The processing circuitry 702 is configured to align a first distance overlay line 56a with the first portion 63a of the emitted light pattern of the first image data, align a second distance overlay line 56b with the second portion 63b of the emitted light pattern of the second image data and align a third distance overlay line 56c with the third portion 63c of the emitted light pattern of the third image data. In some examples, the processing circuitry 702 analyzes the first image data 54a, the second image data 54b, and the third image data 54c to identify the precise location and characteristics of the emitted light pattern portions 63a, 63b, and 63c. The processing circuitry then adjusts the position and orientation of the distance overlay lines 56a, 56b, and 56c to precisely match these features, accounting for any distortion or perspective effects caused by the camera lenses or vehicle geometry.

For the purposes of this alignment, “position data” refers to a set of parameters describing the location and orientation of each feature in the image. This includes, but is not limited to, the x and y pixel coordinates of the feature's centroid, the angle of the feature's major axis relative to a reference direction, and the intensity or color of the feature. The processing circuitry 702 analyzes this position data using a combination of geometric transformations and optimization algorithms. For example, the circuitry may apply a perspective transformation to account for the camera's viewing angle and lens distortion, and then use a least-squares algorithm to minimize the difference between the measured positions of the features and their expected positions based on a pre-defined calibration model.

The processing circuitry 702 may employ sophisticated algorithms and control logic to ensure accurate and reliable camera alignment. In one example, the system first analyzes the image data 54a, 54b, 54c to detect the presence and characteristics of the emitted light pattern 62. This may involve techniques such as edge detection, corner detection, or pattern recognition to identify the key features of the pattern. The processing circuitry then compares the detected features to a known reference model of the light pattern, which is stored in memory 704. Any deviations between the detected features and the reference model are interpreted as misalignment errors. The processing circuitry then calculates the appropriate adjustments to the distance overlay lines 56a, 56b, and 56c to compensate for these errors, using a combination of geometric transformations, interpolation techniques, and optimization algorithms. To ensure stable and accurate alignment, the system may also employ a feedback control loop that continuously monitors the alignment status and makes small adjustments over time to correct for any drift or variations. The control logic is designed to be robust to noise, outliers, and other sources of error, ensuring reliable performance in a wide range of conditions.

The first portion 63a of the emitted light pattern 62 comprises position data 57a. The second portion 63b of the emitted light pattern 62 comprises position data 57b. The third portion 63c of the emitted light pattern 62 comprises position data 57c.

In some embodiments, alignment of the first and second camera 50a, 50b are performed in a ground plane. This ground plane alignment ensures that the cameras are calibrated to accurately perceive objects and distances on the ground surface, which is important for various applications such as lane departure warning, adaptive cruise control, and automated parking. By aligning the distance overlay lines 56a, 56b within this ground plane, the system can effectively compensate for variations in camera mounting, vehicle suspension, and road surface irregularities. The alignment within the ground plane effectively focuses the camera system on the area most relevant for driving and maneuvering, improving the accuracy and reliability of the sensor data. In other embodiments, the cameras may be aligned to a reference surface or reference plane that is not necessarily the ground. This could be a predetermined plane parallel to the vehicle's chassis, a plane defined by the horizon, or a virtual plane established based on sensor data from other vehicle systems. Alternatively, the cameras may be aligned with respect to a vehicle coordinate system, which is a defined set of axes and origin points fixed to the vehicle's chassis. This allows the system to maintain accurate alignment regardless of the vehicle's orientation relative to the ground or other external references.

In one example, the processing circuitry 702 is further configured to process the position data 57a of the first portion 63a and the position data 57b of the second portion 63b in order to align the first camera 50a and the second camera 50b relative to each other. In one example, the first camera 50a and the second camera 50b are aligned in a ground plane. The ground plane may be a plane extending on the ground G. The ground plane may be plan extending in the x and y-direction. The ground plane may be a horizontal plane.

In one example, the position data is defined by positions on xy-coordinates or on xyz-coordinates. The use of xy-coordinates provides a simplified representation of the position data, suitable for applications where the camera system is primarily concerned with horizontal alignment. In this case, the z-coordinate (height) may be assumed to be constant or may be ignored. Conversely, the use of xyz-coordinates provides a more complete 3D representation of the position data, which may be important for applications where the camera system must account for variations in height or perspective. For example, if the vehicle is parked on an uneven surface or if the cameras are mounted at different heights, the xyz-coordinates can be used to accurately compensate for these variations. The choice between xy and xyz coordinates may depend on the specific requirements of the application and the capabilities of the camera system.

In one example, the processing circuitry 702 is further configured to process the position data 57c of the third portion 63c and the position data 57b of the second portion 63b in order to align the third camera 50c and the second camera 50b relative to each other.

In one example, the processing circuitry 702 is configured to process the position data 57a of the first portion 63a, the position data 57b of the second portion 63b and the position data 57c of the third portion 63c in order to align the first camera 50a, the second camera 50b and the third camera 50c relative to each other.

In one example, the alignment of the respective distance overlay lines 56a-c with the respective portions 63a-c are based on the position data. The position data, which may be defined by xy or xyz coordinates, allows the processing circuitry 702 to calculate the precise spatial relationship between the distance overlay lines and the corresponding features in the emitted light pattern. The alignment process then involves adjusting the position and orientation of the distance overlay lines until they perfectly coincide with the corresponding features in the emitted light pattern, ensuring accurate camera alignment.

In one example, the alignment of the respective distance overlay lines 56a-c with the respective portions 63a-c are based on a delta between the first image data 54a from the first camera 50a, the second image data 54b from the second camera 50b, and the third image data 54c from the third camera 50c. By analyzing the delta, or difference, between the image data captured by the different cameras, the processing circuitry 702 can determine the precise amount of adjustment needed to align the distance overlay lines with the corresponding features in the emitted light pattern. This approach allows the system to compensate for variations in camera position, orientation, and calibration, ensuring accurate alignment even in challenging conditions.

In one example, the position data is used to re-position to field of view of the first camera 50a, the second camera 50b and/or the third camera 50c.

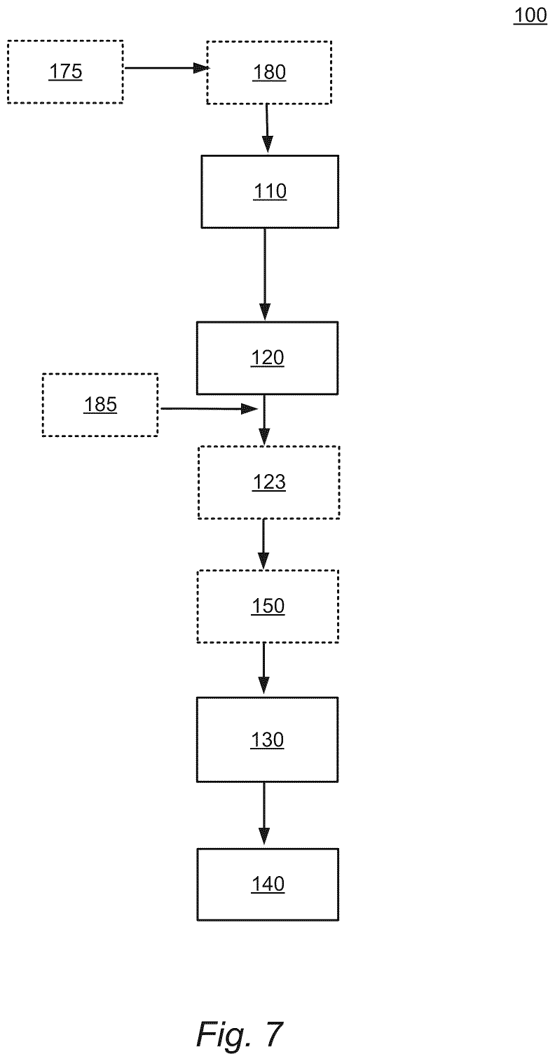

FIG. 7 illustrates an example of a computer-implemented method. Step 110 comprises projecting a light pattern 62 onto a ground G spanning field views F of at least a first camera 50a and a second camera 50b. Step 120 comprises obtaining image data 54a, 54b, 54c from cameras 50. In certain embodiments, two cameras are used. In other embodiments, three cameras may be used. In certain embodiments, first image data 54a is obtained from the first camera 50a, second image data is obtained from the second camera 50b. The first image data 54a includes a first portion 63a of the emitted light pattern 62. The second image data 54b includes a second portion 63b of the emitted light pattern 62. In certain embodiments, a third camera may be used with third image data obtained from a third camera. In other embodiments, more cameras may be used.

The method further comprises aligning 130, a first distance overlay line 56a with the first portion 63a of the emitted light pattern 62 of the first image data 54a and aligning 130 a second distance overlay line 56b with the second portion 63b of the emitted light pattern of the second image data 54b. In one example, the alignment 130 is performed by receiving a user input. The user input may for example be received using a touch-display 30. In an alternative example, the alignment 130 is performed automatically by the processing circuitry 702. The alignment may be performed by using a machine learning algorithm trained on a dataset of calibrated camera systems to accurately determine the optimal alignment parameters based on the captured image data and vehicle sensor data. The processing circuitry may also employ iterative optimization techniques to refine the alignment over time, ensuring long-term accuracy and stability.

The camera alignment process can be initiated in several ways. The driver may manually initiate the alignment process by pushing a button on the dashboard, selecting an option within the vehicle's infotainment system, or using a mobile app connected to the vehicle. Alternatively, the alignment process can be automatically initiated each time the vehicle is started, ensuring that the cameras are always properly aligned. In another embodiment, the alignment process can be performed periodically based on a timer, ensuring long-term accuracy and stability. The alignment process can also be triggered by sensor data indicating a potential misalignment. For example, the system may monitor the vehicle's load sensors, suspension sensors, or tire pressure sensors and initiate the alignment process if significant changes are detected. The system may also monitor the vehicle's inertial measurement unit (IMU) to detect rough road conditions or impacts that could cause misalignment. Further, the alignment process can be initiated as part of a routine vehicle diagnostic check, ensuring that the camera system is functioning properly.

In embodiments where the alignment process is at least partially manual, the driver can adjust the position and orientation of the distance overlay lines 56a and 56b using an input device. The driver may be guided by visual cues and feedback from the system, such as a real-time display of the camera images and the alignment error. The system may also provide suggestions for optimal overlay line placement based on the captured image data and vehicle sensor data. The driver may then confirm to the system that the changes are appropriate.

Regardless of whether the alignment is performed automatically or manually, the key objective is to achieve a precise match between the distance overlay lines and the corresponding features in the emitted light pattern and the underlying camera images. This ensures that the camera system is accurately calibrated and provides reliable sensor data for the vehicle's various safety and assistance systems.

In one example, the alignment 130 is performed by adjusting the first distance overlay line 56a and/or the second distance overlay line 56b with at least the first or second portion 63a, 63b of the emitted light pattern 62. In an alternative example, the alignment 130 is performed by adjusting at least the first or second portion 63a, 63b of the emitted light pattern 62.

The method may further comprise processing 140 position data of the first portion of the emitted light pattern and position data of the first portion of the emitted light pattern. In one example, the position data may be used to align the first camera 50a and the second camera 50b relative to each other. In one example, the position data is used to alter the field of view of the cameras. In one example, the position data is used for aligning the distance overlay lines with the portions of the emitted light pattern.

In one example, the position data is used to create a common reference for all cameras. The common reference may be a common reference point or a common reference line. The common reference may be used to connect the field of view of the plurality of cameras. The connected field of views of the cameras may be used to align the cameras relative each other. Hence, in one example, the method comprises obtaining or processing position data of the portions of the emitted light pattern. The method further comprises determining a common reference for the plurality of cameras, and aligning the cameras based on the common reference.

The method may optionally further comprise obtaining 123 a first distance overlay line and obtaining 123 a second distance overlay line. In one example, the distance overlay line 56a, 56b is obtained from the processing circuitry 702. In another example, the distance overlay line 56a, 56b is obtained from the cameras 50a, 50b.

The method may optionally further comprise displaying 150 the first portion 63a of the emitted light pattern 62 and the first distance overlay line 56 on at least one display 30a, 30b, 30c, and/or displaying 150 the second portion 63b of the emitted light pattern 62 and the second distance overlay line 56b on at least one display 30a, 30b, 30c. In one example, the alignment of the first and second distance overlay line 56a, 56b aligns the first and second camera 50a, 50b in a ground plane.

The method may further comprise adapting or altering 180 the emitted light pattern 62. The adapting/altering of the emitted light pattern 62 may comprise altering the shape, dimension, wavelength, intensity and/or brightness of the emitted light. Hence, the adaptation of the emitted light pattern 62 comprises changing the wavelength of the emitted light, changing the intensity of the emitted light and/or changing the shape of the emitted light pattern. The adapting/altering may be made automatically by the processing circuitry 702, by a user prompting the processing circuitry 702 or manually by the user. For example, if the system detects heavy rain, the intensity of the emitted light pattern may be increased to improve visibility, or the wavelength may be shifted towards the infrared spectrum to reduce glare for the driver. This dynamic adaptation enhances the robustness and reliability of the camera alignment system in adverse conditions.

In one example, the processing circuitry 702 is configured to obtain information 175 pertaining to the surrounding conditions of the vehicle. The surrounding conditions of the vehicle may be ambient conditions of the vehicle. The ambient conditions may for example relate to temperature, humidity, air pressure, wind speed, and/or solar radiation. Other examples of ambient conditions relate to road surface conditions (such as rough roads, snow, ice, rain, mud, etc.), and pollution levels.

In one example, the processing circuitry 702 is configured to alter the shape/dimensions of the light pattern 62 based on the obtained information pertaining to the surrounding conditions of the vehicle. In yet one example, the user of the vehicle may manually alter the shape of the emitted light pattern 62 based on the obtained information pertaining to the surrounding conditions of the vehicle. For instance, if the road surface is uneven, the dimensions of the light pattern may be expanded to cover a larger area, ensuring that the cameras capture sufficient data for accurate alignment.

In one example, the processing circuitry 702 is configured to obtain information pertaining to the surrounding conditions of the vehicle. The processing circuitry 702 is configured to alter the wavelength based on the obtained information pertaining to the surrounding conditions of the vehicle. In yet one example, the user of the vehicle may manually alter the wavelength of the emitted light pattern 62. For instance, if fog is detected, the wavelength of the emitted light pattern may be shifted towards the red or infrared spectrum, which is less susceptible to scattering by fog particles, thereby improving the visibility of the pattern and the accuracy of the camera alignment.

In one example, the processing circuitry 702 is configured to obtain information pertaining to the surrounding conditions of the vehicle, and to alter the intensity and/or brightness based on the obtained information pertaining to the surrounding conditions of the vehicle. In yet one example, the user of the vehicle may manually alter the intensity of the emitted light pattern 62. For example, in low-light conditions, the intensity of the emitted light pattern may be increased to ensure that it is clearly visible to the cameras. Conversely, in bright sunlight, the intensity may be reduced to prevent glare or saturation of the camera sensors.

In one example, the processing circuitry 702 is configured to recognize 185 the shape of the light pattern 62. The specific shape may be associated with characteristics of a specific vehicle type. The processing circuitry 702 may thus be configured to identify the shape of the light pattern 62, and based on said identification retrieve information relating to the specific vehicle 10. The information may for example pertain to vehicle type, wheel size, wheel numbers, dimensions of the vehicle, dimensions of the trailer unit, dimensions of the tractor, information of the camera system on the vehicle, and other relevant characteristics of the vehicle. In other words, the processing circuitry 702 is configured to identify 185 the shape of the light pattern 62, the first portion 63a and/or the second portion 63b, wherein the shape is associated with an identifier containing characteristics of the vehicle 10.

The method may further comprise obtaining 120 third image data 54c from a third camera 50c, wherein the third image data 54c includes a third portion 63c of the emitted light pattern 62 from the at least one light projector 60. The method further comprises aligning 123 a third distance overlay line 56c with the third portion 63c of the emitted light pattern 62 of the third image data 54c.

In one example, all method steps of the camera alignment process, including projecting the light pattern, obtaining image data, and aligning the overlay lines, are performed automatically by the processing circuitry 702 without any driver intervention. In some embodiments, even when the alignment process is fully automated, the visual information module 30 displays the progress and results of the alignment to the driver, providing them with confidence that the system is functioning correctly. The display may show the emitted light pattern, the overlay lines, and an indication of the alignment accuracy, such as a color-coded scale or a numerical score.

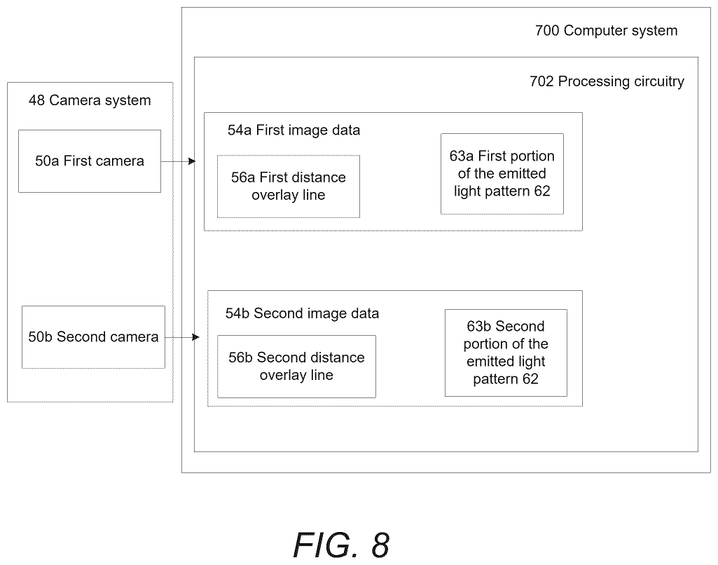

FIG. 8 depicts a computer system 700 comprising processing circuitry 702 configured to project 110, from at least one light projector 60 of a vehicle 10, a light pattern 62 onto a ground G spanning field views of a first camera 50a and a second camera 50b, obtain 120 first image data 54a from the first camera 50a, wherein the first image data 54a includes a first portion 63a of the emitted light pattern 62 from the at least one light projector 60 and obtain 120 second image data 54b from the second camera 50b, wherein the second image data 54b includes a second portion 63b of the emitted light pattern from the at least one light projector 60. The processing circuitry 702 is further configured to align 130 a first distance overlay line 56a with the first portion 63a of the emitted light pattern 62 of the first image data 54a and align 130 a second distance overlay line 56b with the second portion 63b of the emitted light pattern of the second image data 54b.

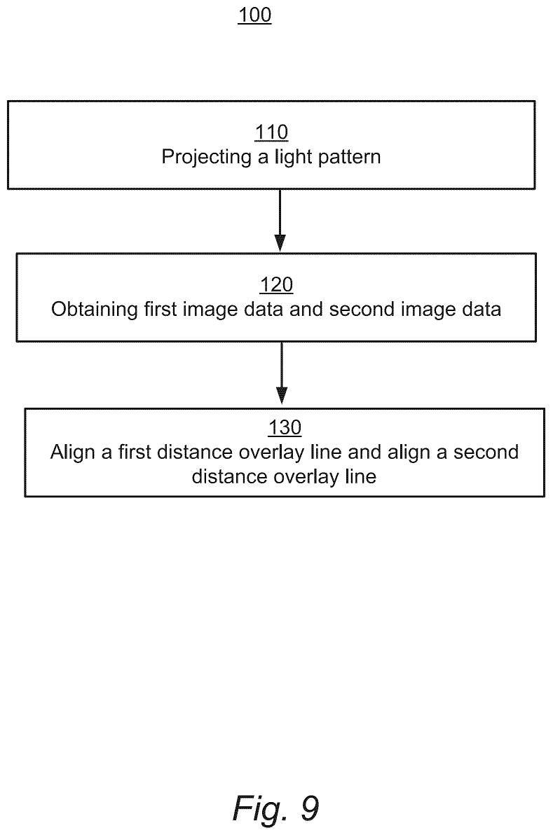

FIG. 9 depicts a computer-implemented method according to an example. The method comprises projecting 110, from at least one light projector 60 of a vehicle 10, a light pattern 62 onto a ground G spanning field views of a first camera 50a and a second camera 50b, obtaining 120, from a camera system 48, first image data 54a from the first camera 50a, wherein the first image data 54a includes a first portion 63a of the emitted light pattern 62 from the at least one light projector 60. The method further comprises obtaining 120, from a camera system 48, second image data 54b from the second camera 50b, wherein the second image data 54b includes a second portion 63b of the emitted light pattern from the at least one light projector 60. The method further comprises aligning 130, a first distance overlay line 56a with the first portion 63a of the emitted light pattern 62 of the first image data 54a and aligning 130 a second distance overlay line 56b with the second portion 63b of the emitted light pattern of the second image data 54b.

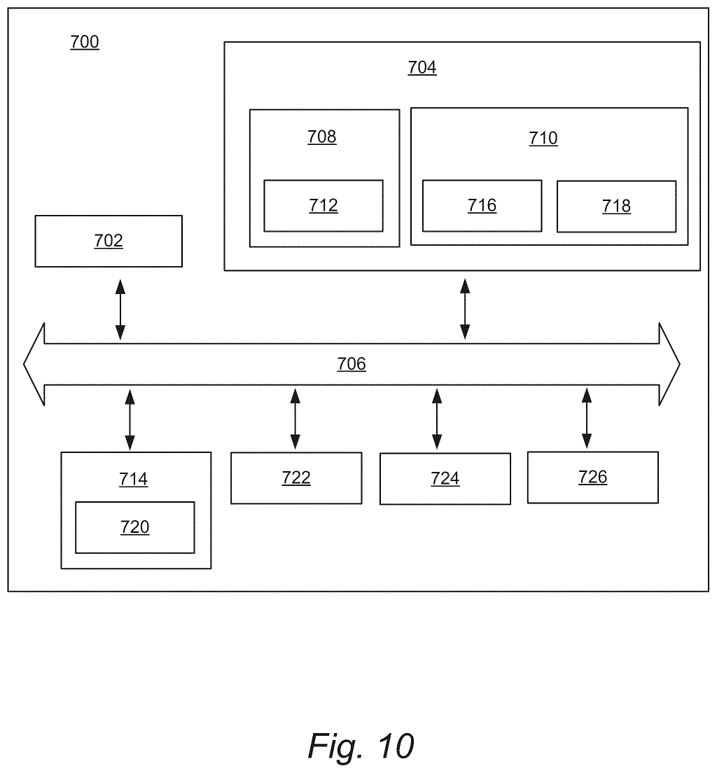

FIG. 10 is a schematic diagram of a computer system 700 for implementing examples disclosed herein. The computer system 700 is adapted to execute instructions from a computer-readable medium to perform these and/or any of the functions or processing described herein. The computer system 700 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 700 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 700 may comprise at least one computing device or electronic device capable of including firmware, hardware, and/or executing software instructions to implement the functionality described herein. The computer system 700 may include processing circuitry 702 (e.g., processing circuitry including one or more processor devices or control units), a memory 704, and a system bus 706. The computer system 700 may include at least one computing device having the processing circuitry 702. The system bus 706 provides an interface for system components including, but not limited to, the memory 704 and the processing circuitry 702. The processing circuitry 702 may include any number of hardware components for conducting data or signal processing or for executing computer code stored in memory 704. The processing circuitry 702 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 702 may further include computer executable code that controls operation of the programmable device.

The system bus 706 may be any of several types of bus structures that may further interconnect to a memory bus (with or without a memory controller), a peripheral bus, and/or a local bus using any of a variety of bus architectures. The memory 704 may be one or more devices for storing data and/or computer code for completing or facilitating methods described herein. The memory 704 may include database components, object code components, script components, or other types of information structure for supporting the various activities herein. Any distributed or local memory device may be utilized with the systems and methods of this description. The memory 704 may be communicably connected to the processing circuitry 702 (e.g., via a circuit or any other wired, wireless, or network connection) and may include computer code for executing one or more processes described herein. The memory 704 may include non-volatile memory 708 (e.g., read-only memory (ROM), erasable programmable read-only memory (EPROM), electrically erasable programmable read-only memory (EEPROM), etc.), and volatile memory 710 (e.g., random-access memory (RAM)), or any other medium which can be used to carry or store desired program code in the form of machine-executable instructions or data structures and which can be accessed by a computer or other machine with processing circuitry 702. A basic input/output system (BIOS) 712 may be stored in the non-volatile memory 708 and can include the basic routines that help to transfer information between elements within the computer system 700.

The computer system 700 may further include or be coupled to a non-transitory computer-readable storage medium such as the storage device 714, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 714 and other drives associated with computer-readable media and computer-usable media may provide non-volatile storage of data, data structures, computer-executable instructions, and the like.

Computer-code that is hard coded or soft coded may be provided in the form of one or more modules. The module(s) can be implemented as software and/or hard-coded in circuitry to implement the functionality described herein in whole or in part. The modules may be stored in the storage device 714 and/or in the volatile memory 710, which may include an operating system 716 and/or one or more program modules 718. All or a portion of the examples disclosed herein may be implemented as a computer program 720 stored on a transitory or non-transitory computer-usable or computer-readable storage medium (e.g., single medium or multiple media), such as the storage device 714, which includes complex programming instructions (e.g., complex computer-readable program code) to cause the processing circuitry 702 to carry out actions described herein. Thus, the computer-readable program code of the computer program 720 can comprise software instructions for implementing the functionality of the examples described herein when executed by the processing circuitry 702. In some examples, the storage device 714 may be a computer program product (e.g., readable storage medium) storing the computer program 720 thereon, where at least a portion of a computer program 720 may be loadable (e.g., into a processor) for implementing the functionality of the examples described herein when executed by the processing circuitry 702. The processing circuitry 702 may serve as a controller or control system for the computer system 700 that is to implement the functionality described herein.

The computer system 700 may include an input device interface 722 configured to receive input and selections to be communicated to the computer system 700 when executing instructions, such as from a keyboard, mouse, touch-sensitive surface, etc. Such input devices may be connected to the processing circuitry 702 through the input device interface 722 coupled to the system bus 706 but can be connected through other interfaces, such as a parallel port, an Institute of Electrical and Electronic Engineers (IEEE) 1394 serial port, a Universal Serial Bus (USB) port, an IR interface, and the like. The computer system 700 may include an output device interface 724 configured to forward output, such as to a display, a video display unit (e.g., a liquid crystal display (LCD) or a cathode ray tube (CRT)). The computer system 700 may include a communications interface 726 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1: A computer system comprising processing circuitry configured to: project, from at least one light projector of a vehicle, a light pattern onto a ground spanning field views of a first camera and a second camera, obtain first image data from the first camera, wherein the first image data includes a first portion of the emitted light pattern from the at least one light projector; obtain second image data from the second camera, wherein the second image data includes a second portion of the emitted light pattern from the at least one light projector; align a first distance overlay line with the first portion of the emitted light pattern of the first image data by adjusting the first distance overlay line or adjusting the first portion of the emitted light pattern; and align a second distance overlay line with the second portion of the emitted light pattern of the second image data by adjusting the second distance overlay line or adjusting the second portion of the emitted light pattern.

Example 2: The computer system of example 1, wherein the alignment of at least one of the first distance overlay line and the second distance overlay line is performed by receiving a user input.

Example 3: The computer system of example 1, wherein the alignment of at least one of the first distance overlay line and the second distance overlay line is performed automatically by the processing circuitry.

Example 4: The computer system of any of example 1-3, the processing circuitry is further configured to process position data of the first portion of the emitted light pattern and position data of the second portion of the emitted light pattern, align the first distance overlay line with the first portion of the emitted light pattern based on the position data; and align the second distance overlay line with the second portion based on the position data.

Example 5: The computer system of any of example 1-4, the alignment of the first and second distance overlay line aligns the first and second camera in a ground plane.

Example 6: the processing circuitry is further configured to process position data of the first portion of the emitted light pattern and position data of the second portion of the emitted light pattern, and reposition the field of view for the first camera and the second camera based on the position data.

Example 7: The computer system of any of example 1-6, wherein the first portion and the second portion have the same position data.

Example 8: The computer system of any of example 1-7, wherein the processing circuitry is further configured to: at least display the first portion of the emitted light pattern and the first distance overlay line on at least one display, or display the second portion of the emitted light pattern and the second distance overlay line on at least one display.

Example 9: The computer system of any of example 1-8, wherein the processing circuitry is further configured to: obtain a first distance overlay line, and obtain a second distance overlay line.

Example 10: The computer system of any of example 1-9, wherein the processing circuitry is further configured to obtain information pertaining to the surrounding conditions of the vehicle; and adapt the emitted light pattern based on said obtained information.

Example 11: The computer system of example 10, wherein the adaptation of the emitted light pattern comprises at least changing the wavelength of the emitted light, changing the intensity of the emitted light or changing the shape of the emitted light pattern.

Example 12: The computer system of example 10 or 11, wherein the information pertaining to the surrounding conditions of the vehicle comprises one or more of: temperature, humidity, weather, air pressure, wind speed, solar radiation, pollution levels, and road surface conditions.

Example 13: The computer system of any of example 1-12, wherein the processing circuitry is further configured to at least identify the shape of the light pattern, the first portion or the second portion, wherein the shape is associated with an identifier containing characteristics of the vehicle.

Example 14: The computer system of any of example 1-13, wherein at least the shape of the light pattern, the first portion or the second portion is a bar code or a logotype of the vehicle brand.

Example 15: The computer system of any of example 1-12, wherein the processing circuitry is further configured to obtain third image data from a third camera, the third image data including a third portion of the emitted light pattern from the at least one light projector; align a third distance overlay line with the third portion of the emitted light pattern of the first image data; process position data of the first portion of the emitted light pattern, position data of the second portion of the emitted light pattern and position data of the third portion of the emitted light pattern to align the first camera, the second camera and the third camera relative to each other.

Example 16: The computer system of any of example 1-15, wherein the at least the first portion or the second portion comprises at least one point in a line segment.

Example 17: A vehicle comprising at least one light projector, a camera system and the computer system of any of example 1-16.

Example 18: The vehicle of example 17, wherein the at least one light projector is arranged on a rear portion of the vehicle.

Example 19: The vehicle of example 18, wherein the camera system comprises at least two cameras, being a left rear-facing camera, a right rear-facing camera or a center rear-facing camera.

Example 20: A computer-implemented method comprising projecting, from at least one light projector of a vehicle, a light pattern onto a ground spanning field views of a first camera and a second camera, obtaining, from a camera system, first image data from the first camera, wherein the first image data includes a first portion of the emitted light pattern from the at least one light projector; obtaining, from a camera system, second image data from the second camera, wherein the second image data includes a second portion of the emitted light pattern from the at least one light projector; aligning a first distance overlay line with the first portion of the emitted light pattern of the first image data by adjusting the first distance overlay line or adjusting the first portion of the emitted light pattern; and aligning a second distance overlay line with the second portion of the emitted light pattern of the second image data by adjusting the second distance overlay line or adjusting the second portion of the emitted light pattern.

Example 21: A computer program product comprising program code for performing, when executed by the processing circuitry, the method of example 20.

Example 22: A non-transitory computer-readable storage medium comprising instructions, which when executed by the processing circuitry, cause the processing circuitry to perform the method of example 20.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system for aligning at least a first camera and a second camera of a vehicle, the computer system comprising processing circuitry configured to:
project, from at least one light projector of the vehicle, a light pattern onto a ground spanning field views of the first camera and the second camera,
obtain first image data from the first camera, wherein the first image data includes a first portion of the emitted light pattern from the at least one light projector;
obtain second image data from the second camera, wherein the second image data includes a second portion of the emitted light pattern from the at least one light projector;
align a first distance overlay line with the first portion of the emitted light pattern of the first image data by adjusting the first distance overlay line or adjusting the first portion of the emitted light pattern;
align a second distance overlay line with the second portion of the emitted light pattern of the second image data by adjusting the second distance overlay line or adjusting the second portion of the emitted light pattern,
wherein the alignment of the first and second distance overlay line aligns the first and second camera in a ground plane.

2. The computer system of claim 1, wherein the alignment of at least one of the first distance overlay line and the second distance overlay line is performed by receiving a user input.

3. The computer system of claim 1, wherein the alignment of at least one of the first distance overlay line and the second distance overlay line is performed automatically by the processing circuitry.

4. The computer system of claim 1, wherein the alignment of the first distance overlay line with the first portion and the alignment of the second distance overlay line with the second portion are visibly shown on at least one display.

5. The computer system of claim 1, wherein the processing circuitry is further configured to:
display the first portion of the emitted light pattern and the first distance overlay line on at least one display, and
display the second portion of the emitted light pattern and the second distance overlay line on at least one display.

6. The computer system of claim 1, wherein the processing circuitry is further configured to:
process position data of the first portion of the emitted light pattern and position data of the second portion of the emitted light pattern
align the first distance overlay line with the first portion of the emitted light pattern based on the processed position data; and
align the second distance overlay line with the second portion based on the processed position data.

7. The computer system of claim 1, wherein the ground plane is defined as a plane extending in the x and y direction.

8. The computer system of claim 1, wherein the processing circuitry is further configured to:
process position data of the first portion of the emitted light pattern and position data of the second portion of the emitted light pattern; and
re-position the field of view for the first camera and the second camera based on the processed position data.

9. The computer system of claim 1, wherein the processing circuitry is further configured to:
obtain information pertaining to the surrounding conditions of the vehicle; and
adapt the emitted light pattern based on said obtained information.

10. The computer system of claim 9, wherein the adaptation of the emitted light pattern comprises at least one of changing the wavelength of the emitted light, changing the intensity of the emitted light or changing the shape of the emitted light pattern.

11. The computer system of claim 9, wherein the information pertaining to the surrounding conditions of the vehicle comprises one or more of: temperature, humidity, weather, air pressure, wind speed, solar radiation, pollution levels, and road surface conditions.

12. The computer system of claim 1, wherein the processing circuitry is further configured to:
identify at least one of the shape of the light pattern, the first portion or the second portion, wherein the shape is associated with an identifier containing characteristics of the vehicle.

13. The computer system of claim 1, wherein the processing circuitry is further configured to:
obtain third image data from a third camera, the third image data including a third portion of the emitted light pattern from the at least one light projector; and
process position data of the first portion of the emitted light pattern, position data of the second portion of the emitted light pattern and position data of the third portion of the emitted light pattern;
align the first distance overlay line with the first portion of the emitted light pattern based on the processed position data;
align the second distance overlay line with the second portion based on the processed position data; and
align a third distance overlay line with the third portion of the emitted light pattern of the first image data based on the processed position data.

14. The computer system of claim 1, wherein the alignment process is automatically triggered based on one or more of: data from one or more sensors indicating a potential misalignment, upon vehicle start-up, periodically based on a pre-set timer, or as part of a routine vehicle diagnostic check.

15. The computer system of claim 1, wherein the processing circuitry is further configured to generate a notification to the driver upon completion of the alignment process.

16. A vehicle comprising at least one light projector, a camera system and the computer system of claim 1.

17. The vehicle of claim 16, further comprising a display for showing the alignment of the first distance overlay line and a second distance overlay line.

18. A computer-implemented method for aligning at least a first camera and a second camera of a vehicle comprising:
projecting, from at least one light projector of the vehicle, a light pattern onto a ground spanning field views of the first camera and the second camera,
obtaining, from a camera system, first image data from the first camera and second image data from the second camera, wherein the first image data includes a first portion of the emitted light pattern from the at least one light projector and the second image data includes a second portion of the emitted light pattern from the at least one light projector;
aligning a first distance overlay line with the first portion of the emitted light pattern of the first image data by adjusting the first distance overlay line or adjusting the first portion of the emitted light pattern; and
aligning a second distance overlay line with the second portion of the emitted light pattern of the second image data by adjusting the second distance overlay line or adjusting the second portion of the emitted light pattern;
wherein the alignment of the first and second distance overlay line aligns the first and second camera in a ground plane.

19. A computer program product comprising program code for performing, when executed by the processing circuitry, the method of claim 18.

20. A non-transitory computer-readable storage medium comprising instructions, which when executed by the processing circuitry, cause the processing circuitry to perform the method of claim 18.
